(19) United States
(12) Patent Application Publication
(10) Pub. No.: US 2009/0256534 A1
(43) Pub. Date: Oct. 15, 2009

(54) POWER SUPPLY CONTROL METHOD AND APPARATUS

(75) Inventors: John G. Videtich, Holland, MI (US); Paul C. Duckworth, Holland, MI (US); Warren E. Guthrie, West Olive, MI (US); Matthew T. Shinew, Grand Haven, MI (US); David L. Klamer, Zeeland, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: TWISTHINK, L.L.C., Holland, MI (US)

(21) Appl. No.: 12/420,084

(22) Filed: Apr. 8, 2009

Related U.S. Application Data
(60) Provisional application No. 61/123,919, filed on Apr. 14, 2008.

(51) Int. Cl. G05F 1/10

(52) U.S. Cl. 323/235

(57) ABSTRACT

A power supply system including a controller capable of regulating a pulsed output voltage. The power supply system includes a load, a switching circuit connected to the load, and a controller electrically connected to the switching circuit. The controller is adapted to transmit a switching signal to the switching circuit for generating an adjustable duty cycle pulsed voltage to provide power to the controller and the load. The controller is further adapted to adjust the pulsed output voltage against a reference voltage by varying the duty cycle of the switching signal. The power supply system may include a start-up circuit electrically connected to the controller and adapted to provide a start-up voltage to the controller until the controller is powered by an operating voltage through the switching circuit.

### BACKGROUND OF THE INVENTION

This application claims priority from provisional U.S. Application No. 61/123,919 filed Apr. 14, 2008 and entitled “Switching Power Supply Control Method for Low-Power Embedded Systems.”

The present invention relates to power supply systems, and more particularly to power supply systems including an embedded microcontroller capable of regulating a voltage or current.

Power supply systems are prevalent in modern life and often include an available mains AC source voltage, a mains regulator or rectifier, and a linear or switching DC-to-DC converter for generating a low power DC output. In many instances, the power supply system supplies power to an embedded device and its internal or embedded microcontroller. The embedded device, for example a wall timer, will often include one or more peripheral devices, for example an LCD and keypad for providing data input and output. The embedded microcontroller will generally include a system processor, associated memory and control logic. Additionally, the embedded microcontroller will typically be used to control processes or devices unrelated to the supply of power to either of the embedded device or the microcontroller itself.

FIG. 1 shows a typical prior art power supply 10. An AC source voltage 12 is connected to filter diode 14 and filter capacitor 16 for creating a rectified voltage V₀. A switching regulator 18, for example either of a step-down or a boost switching circuit, provides a regulated output voltage V₁ to an embedded device 20 across a filter inductor 22. The switching regulator 18 measures the output voltage V₁ against a reference voltage and further regulates the input voltage V₀ to achieve the desired output. An embedded device 20 and an embedded microcontroller 24 connect only to the output voltage V₁ and do not otherwise interact with the power supply 10.

Power supply systems can also include one or more relays to carry a mains voltage to a load. A wall timer for example might use the switching power supply in FIG. 1 to energize a 24V relay with a switching signal in the form of a high frequency square wave whose average voltage V₁ is approximately 24V. Once energized, the relay would close and provide a conducting connection between a mains voltage and a load, for example one or more lighting fixtures. However, it has been found that conventional power supply systems actuate a relay from rest over an extended period, potentially resulting in actuation of the relay (i.e., closure of the relay contacts) during peak mains voltage. This can have the undesired effect of imparting an inrush current to the load and inducing arcing across the relay contacts.

### SUMMARY OF THE INVENTION

The aforementioned problems are overcome by the present invention, which includes a power supply having a relay with a relay coil and at least two switch contacts, a switching circuit, a zero crossing circuit, and a microcontroller connected in series between the zero crossing circuit and the switching circuit, wherein the microcontroller is adapted to transmit a switching signal to the switching circuit for closing the relay substantially at zero crossing of a source voltage. The switching signal induces a start up voltage in the relay coil followed by a holding voltage across the relay coil, wherein the start up voltage is greater than the time average of the holding voltage. Additionally, a voltage feedback circuit is optionally connected in series between the relay coil and the microcontroller, and the microcontroller is adapted to provide a pulse width modulated switching signal to the switching circuit for inducing a holding voltage across the relay coil proportional to the duty cycle of the switching signal.

In another embodiment, the present invention includes a power supply system having a start-up circuit, a switching circuit, and a microcontroller connected in series between the start-up circuit and the switching circuit. The start-up circuit includes a voltage regulator for generating a start-up voltage, the voltage regulator capable of being disabled in response to a condition. The switching circuit is connected in parallel with the start-up circuit, and a microcontroller is adapted to transmit a pulsed waveform switching signal to the switching circuit to generate an operating voltage, wherein the condition is met where the startup voltage is at least equal to a reference voltage for a predetermined period of time. The power supply may further include a supply circuit coupled to the start-up circuit and the switching circuit, and a linear regulator for converting either of the start-up voltage or operating voltage into a supply voltage for the microcontroller.

In another embodiment, the present invention includes a power supply system having a microcontroller, an inductive load having an output connected to the microcontroller, a capacitor connected to the inductive load, and a transistor controlled by the microcontroller, wherein the microcontroller is adapted to transmit a switching signal to the transistor for generating an adjustable duty cycle input voltage across the inductive load, with the inductive load and capacitor being adapted to smooth the input voltage across the inductive load.

These and other objects, advantages, and features of the invention will be more fully understood and appreciated by reference to the descriptions of the current embodiments and the drawings.

### BRIEF DESCRIPTION OF THE DRAWINGS

FIG. 1 is circuit diagram of a prior art switching power supply;

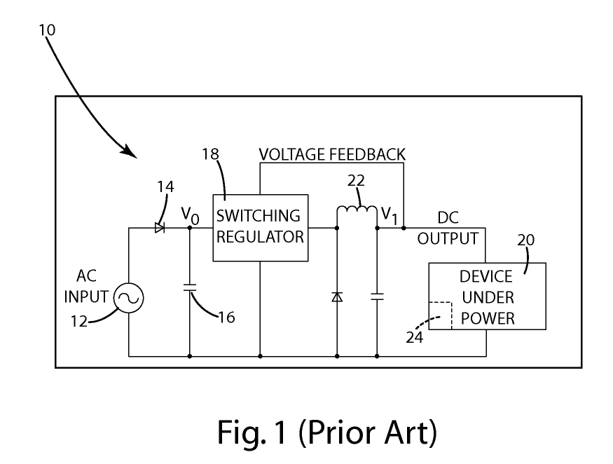

FIG. 2 is a circuit diagram of a first embodiment of the present invention;

FIG. 3 is a circuit diagram of a second embodiment of the present invention;

FIG. 4 is a circuit diagram of a third embodiment of the present invention;

FIG. 5 is a circuit diagram of a fourth embodiment of the present invention;

FIG. 6 illustrates the relay switching signal according to the fourth embodiment of the present invention;

FIG. 7 is a circuit diagram of a fifth embodiment of the present invention;

FIG. 8 is a first circuit diagram of a sixth embodiment of the present invention;

FIG. 9 is a second circuit diagram of the sixth embodiment of the present invention;

FIG. 10 is a flow chart according to the sixth embodiment of the present invention;

FIG. 11 is a first circuit diagram of a seventh embodiment of the present invention; and

FIG. 12 is a second circuit diagram of the seventh embodiment of the present invention.

### DESCRIPTIONS OF THE CURRENT EMBODIMENTS

### I. MICROCONTROLLER-CONTROLLED SWITCHING POWER SUPPLY

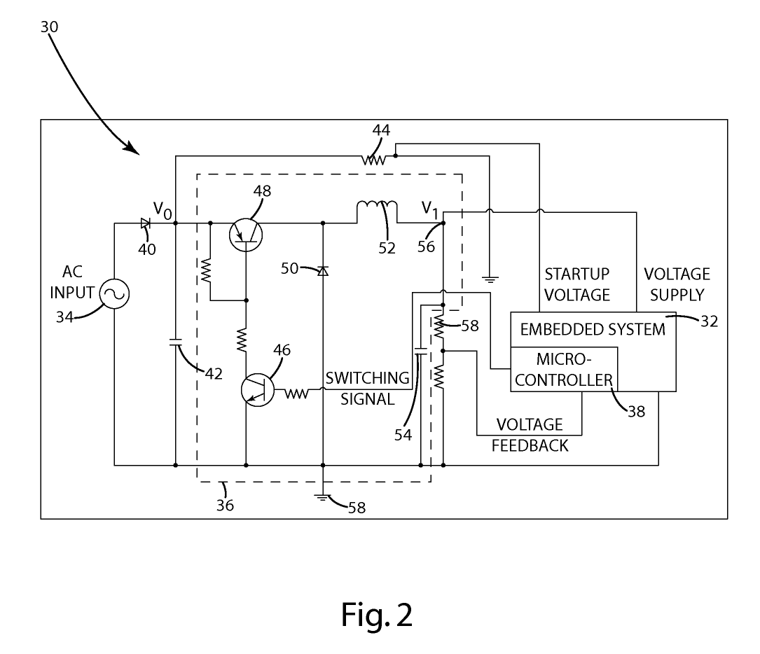

A power supply system constructed in accordance with a first embodiment of the present invention is illustrated in the drawings and generally designated 30. As depicted in FIG. 2, the system 30 includes an embedded device 32, a source voltage 34, a switching circuit 36, and an embedded microcontroller 38 for controlling the switching circuit 36. The embedded device 32 may be any device utilizing an internal or embedded microcontroller, for example a wall timer, clock, battery charger, microwave, washing machine, or clothing dryer.

As further depicted in FIG. 2, the source voltage 34, optionally a 120V or 240V AC mains voltage, is applied across diode 40 and capacitor 42 to create an unregulated voltage V₀. The voltage V₀ may be applied across series dropping resistor 44 to the embedded device 32 as a startup voltage, or applied to the switching circuit 36. Optionally, the microcontroller may be powered upon startup by a battery (not shown) which may also be used for system state backup in case of power failure. The switching circuit 36 includes transistor 46, transistor 48, diode 50, filter inductor 52 and filter capacitor 54. Transistor 46 is a NPN transistor and includes an emitter connected to ground, a base connected to the microcontroller 38, and a collector connected to the base of transistor 48. PNP transistor 48 includes an emitter connected to the supply circuit input voltage V₀, a base connected to transistor 46, and a collector connected to filter inductor 52. Filter inductor 52 includes a first lead connected to transistor 48 and a second lead connected to node 56. Filter capacitor 54 includes a first lead connected to node 56, and a second lead connected to ground 58.

The microcontroller 38 is shown as connected to the output voltage V₁ at node 56 across resistor 58. The microcontroller 38 is suitably adapted to measure the output voltage V₁ for comparison with a reference voltage V_{R}. In operation, the microcontroller 38 transmits a pulse width modulated or frequency modulated switching signal to NPN transistor 46, which then cycles PNP transistor 48 between the open and closed position. In response, switching circuit 36 produces a high frequency square wave having an average voltage approximately equal to voltage V₀ multiplied by the duty cycle of the switching signal. The embedded system 32 receives the desired output voltage V₁, which is less than voltage V₀ but the same polarity. Using standard control system techniques and the above sequence, the microcontroller 38 is able to modulate the output voltage V₁ to be substantially equal to the reference voltage V_{R}, or any voltage as desired. Accordingly, the embedded microcontroller 38 is shown as controlling the switching circuit 36 to provide a regulated output voltage V₁ while remaining capable of operating as an embedded microcontroller.

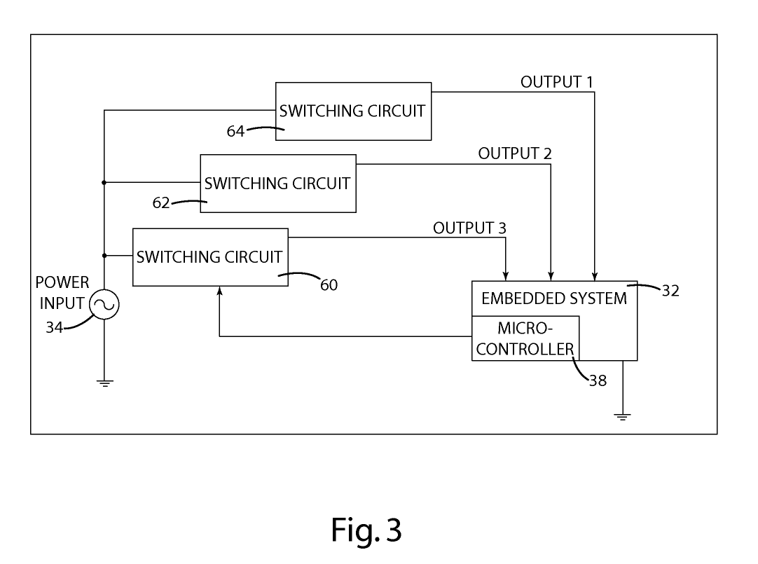

In a second embodiment as depicted in FIG. 3, the power supply system 30 can include multiple switching circuits 60, 62, 64, each controlled by the microcontroller 38 and each capable of providing multiple output voltages to the embedded device 32. While three switching circuits are depicted in FIG. 3, the number of switching circuits and supply voltages may be increased, limited only by the capability of the microcontroller 38.

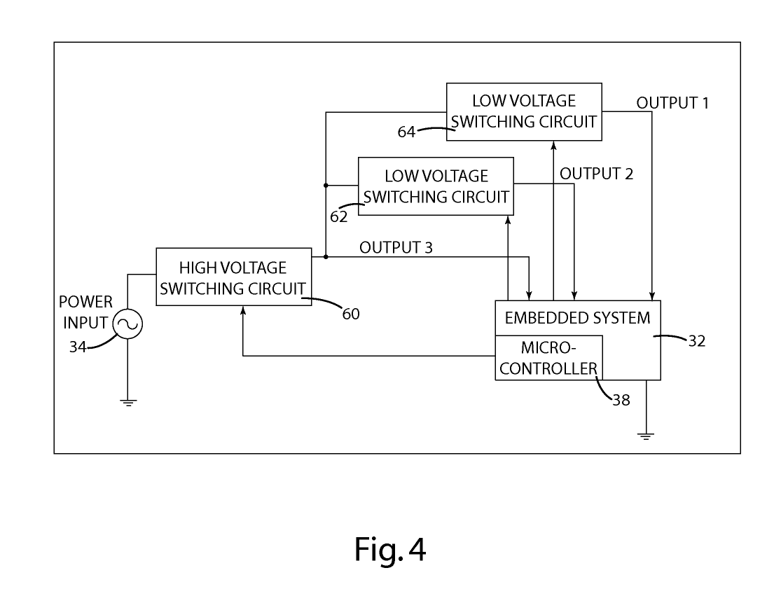

Additionally, as depicted in a third embodiment illustrated in FIG. 4, the output of one switching circuit 60, here a high voltage switching circuit, may be used as the input voltage in one or more subsequent switching circuits 62, 64. Here, the benefit is in the potential of lower-voltage components in the subsequent supplies. Again, the number of switching circuits is limited only by the capability of the controlling microcontroller 30.

### II. MICROCONTROLLER-CONTROLLED SWITCHING POWER SUPPLY WITH RELAY

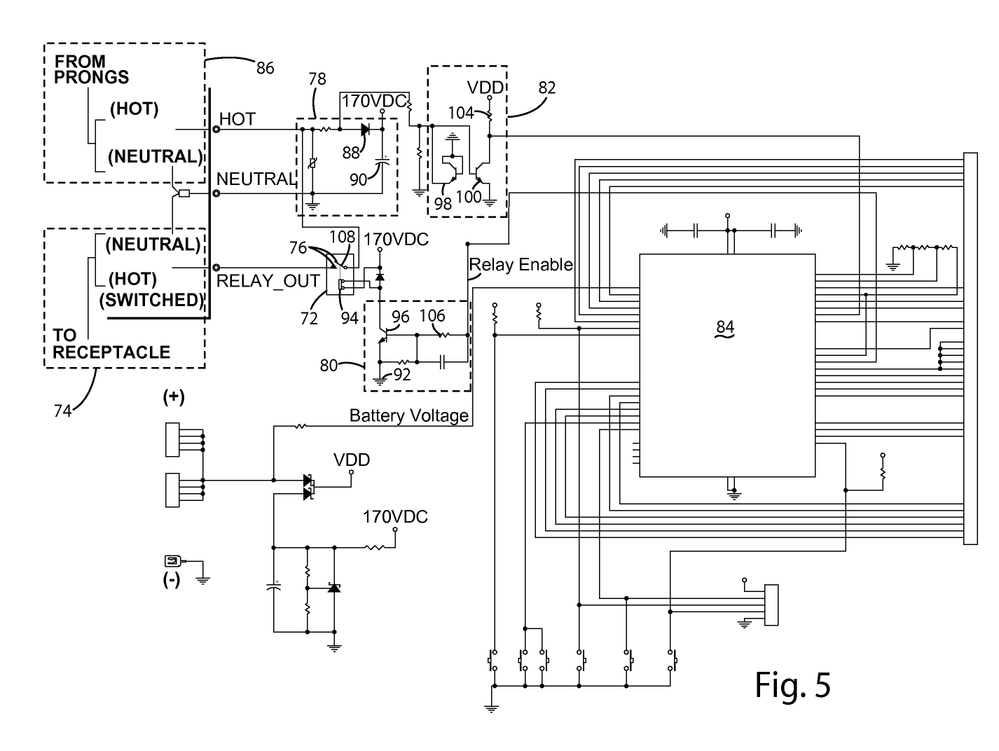

A fourth embodiment of the invention is shown at FIG. 5 and generally designated 70. In this embodiment, a power supply system 70 is configured to energize a relay 72, optionally for use in an embedded device (not shown), while reducing inrush current to the load 74 and while minimizing arcing across the relay contacts 76. The power supply system 70 includes a relay 72, a rectifier 78, a switching circuit 80, a zero crossover circuit 82, and a microcontroller 84. A mains supply 86 generating a source voltage is connected to the relay 72. The relay 72, which is depicted as biased in an open configuration, includes at least two switch contacts 76, wherein the switch contacts 76 provide a conducting path for a source voltage when the relay is in a first state or closed configuration. The relay 72 is connected in series between a load 74 and the mains supply 86. In the present embodiment, mains supply 86 generates a 120V 60 Hz source voltage. The microcontroller 84 may also be an application specific or embedded microcontroller. For example, the microcontroller 84 may be embedded in any number of devices, including wall timers, clocks, battery chargers, microwaves, washing machines, or clothing dryers.

In addition to providing power to the load through the relay, the source voltage is converted into a DC voltage waveform by rectifier 78. The rectifier is shown as including diode 88 and capacitor 90, and the DC waveform is a 170V DC rail voltage. The rail voltage is connected to ground 92 across the relay coil 94 and transistor 96 for energizing the relay coil 94 in response to the switching circuit 80.

To aid in the actuation of the relay 72 at zero crossing of the source voltage, a zero crossing circuit 82 is connected in series between the source voltage and the microcontroller 84. The zero crossing circuit 82 includes NPN transistor 98, NPN transistor 100, and battery supply voltage 102 supplied across resistor 104 to provide a signal indicating zero crossover of the source voltage. The microcontroller 84 is further connected to the switching circuit 80, and in particular the microcontroller 84 is connected across resistor 106 to the base of NPN transistor 96. Transistor 96 emitter is connected to ground 92, and at least one of the transistor 92 collector and emitter is connected to the relay coil 94. Here, the transistor 96 emitter is connected to ground and the transistor 96 collector is connected to the relay coil 94.

When it is desirable to provide source voltage to the load 74 across the relay 72, the zero crossing circuit 82 detects zero crossover in the source voltage and transmits a zero crossing signal to the microcontroller 84. The microcontroller 84 then transmits a switching signal of sufficient voltage to the base of NPN transistor 96 a period of time in advance of a subsequent zero crossover, optionally in advance of the next zero crossover. When current is allowed to flow across the relay coil 94 to ground 92 through the ‘open’ transistor 96, a relay armature 108 connects the switching contacts 76 substantially at zero crossover of the source voltage. Accordingly, the microcontroller 84 is adapted to transmit a switching signal to the switching circuit 80 in advance of a subsequent zero crossover in the source voltage to place the relay 72 in the closed configuration substantially at zero crossover.

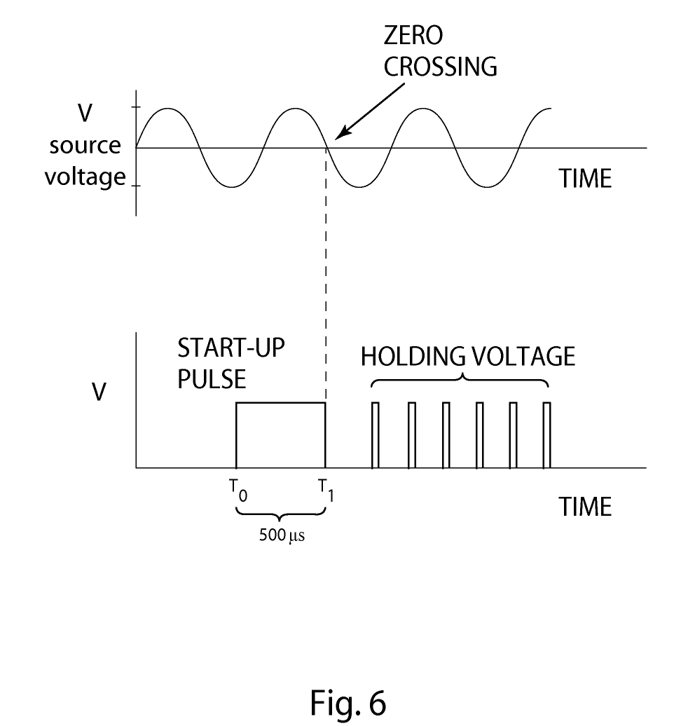

Though the above sequence transpires on a scale of several milliseconds, the closure of the relay switching contacts 76 often lags behind the initial switching signal from the microcontroller 84. Relay delay of as little as four milliseconds can result in closure ninety degrees out of phase for a 60 Hz waveform if not carefully timed. In order to overcome delay in the relay 72 and to close the relay 72 substantially at zero crossover, the microcontroller 84 provides for a relatively high voltage start-up pulse to NPN transistor 96 from time To in advance of zero crossover to time T₁, where time T₁ is selected to coincide with a subsequent or next zero crossing. As shown in FIG. 6, the start-up pulse has a dwell time of 500 microseconds. At or before time T₁, the armature 108 will respond to the energized relay 94 and close the switching contacts 76. As noted above, the start-up pulse is timed by the microcontroller 84 in advance of the next zero crossover, such that T₁ coincides with zero crossing. From time T₁, the microcontroller 84 transmits a high frequency square wave switching signal to NPN transistor 96 to maintain the energized relay 72 in the closed position with a lesser holding voltage. Accordingly, the start up pulse voltage is greater than the time average of the holding voltage. This can provide improved energy savings and can enhance the reliability of the relay.

Though not shown in FIG. 5, the power supply system 70 can measure and modulate the voltage across the relay coil 94 to achieve a desired voltage across the relay coil 94 independent of the mains voltage. For example, it may be desirable to utilize a microcontroller-controlled wall timer having a 24V relay with either of a 120V AC or 220V AC mains voltage. The microcontroller 84 can be adapted to measure the voltage across the relay coil 94 for comparison against a reference voltage. In operation, the microcontroller 84 creates a pulse width modulated switching signal, which then cycles switching transistor 96 between the open and closed position to create an average voltage across the relay coil 94 substantially equal to the rated voltage for the relay 72, for example 24V DC. The system 70 thereby achieves a regulated voltage across the relay coil 94, including the above-disclosed start-up pulse for closing the relay 72 substantially at zero crossover, and a holding voltage to maintain the relay 72 in the closed position.

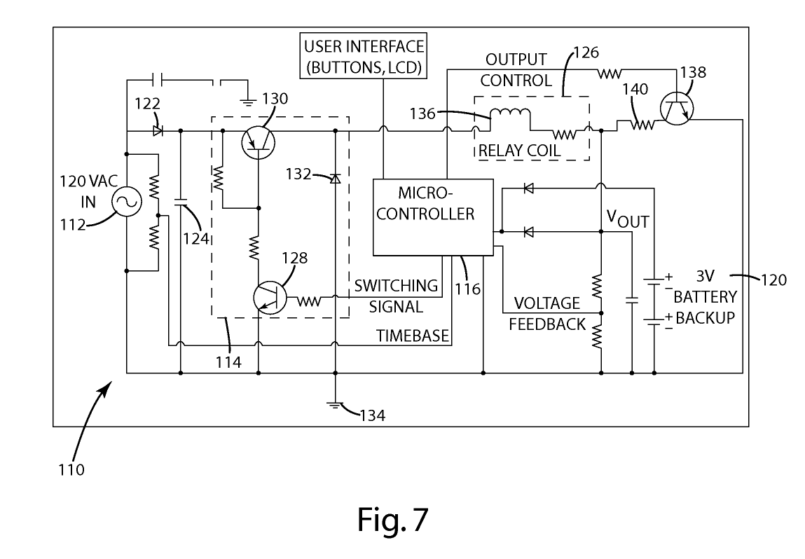

A fifth embodiment of the invention is shown at FIG. 7 and generally designated 110. In this embodiment, the power supply system 110 includes a source voltage 112, a switching circuit 114, a microcontroller 116, a user interface 118, a relay 126 having a relay coil 136, and back-up battery 120. The source voltage 112 is optionally a 120V or 220V AC mains voltage, and is applied across diode 122 and capacitor 124. The microcontroller 116 may be an application specific or embedded microcontroller 116, for example an embedded microcontroller 116 for a wall timer. The switching circuit 114 is connected in series between the microcontroller 116 and relay 126 and includes first transistor 128, second transistor 130, and diode 132. Transistor 128 includes an emitter connected to ground 134, a base connected to the microcontroller 116, and a collector connected to the base of transistor 130. Transistor 130 includes an emitter connected to the mains supply 112, a base connected to transistor 128, and a collector connected to the relay coil 136. The user or input/output interface 118 is connected to the microcontroller 116, optionally including an LCD screen and graphic user interface (GUI) controlled by the microcontroller 116. The low voltage battery 120 is connected to the microcontroller 116 for providing back-up power and for retaining date and time during periods without a supply voltage. Additionally, an output transistor 138 is connected between the relay coil 136 and the microcontroller 116, including a collector connected to the relay coil 136, an emitter connected to ground 134, and a base connected to the microcontroller 116.

In operation, the microcontroller 116 runs an internal clock to compare against user-designated set points provided through the user interface 118. Initial microcontroller power is provided from the low voltage 3V backup battery 120. Power is otherwise provided to the microcontroller 116 across the microcontroller-controlled switching circuit 114 and relay coil 136. As explained above, the microcontroller 116 transmits a pulse width modulated switching signal to transistor 128, which then cycles transistor 130 between the open and closed position. In response, switching circuit 114 produces a high frequency square wave having an average voltage approximately equal to the rectified mains voltage multiplied by the duty cycle of the switching signal.

When the output transistor 138 is off, substantially no current is applied across resistor 140; thus the current flowing through the relay coil 136 is too small to activate the relay 126. To enable the relay 126, the microcontroller 116 enables the output transistor 138. As additional current flows across resistor 140, the microcontroller 116 adjusts the switching signal by increasing its duty cycle, thereby maintaining the required supply voltage, 3V DC in the present example. This extra current turns on relay 126. To disable the relay 126, the microcontroller 116 disables the output transistor 138 and decreases the duty cycle of the switching signal to transistor 128. Accordingly, the microcontroller 116 is shown as fully integrated with the switching power supply 110 to provide a regulated low voltage for the microcontroller 116 and relay 126.

Additionally, the microcontroller 116 includes a time function derived from the frequency of the source voltage 112, 60 Hz in the present embodiment. From this timer function, the microcontroller 116 can detect if the source voltage 112 has been disconnected or power has been lost. The microcontroller 116 will respond to a loss of power by entering a low-power sleep mode running on the batter 120 and maintaining time based on an internal oscillator.

### III. MICROCONTROLLER-CONTROLLED POWER SUPPLY WITH START-UP CIRCUIT and KEEP-ALIVE CIRCUIT

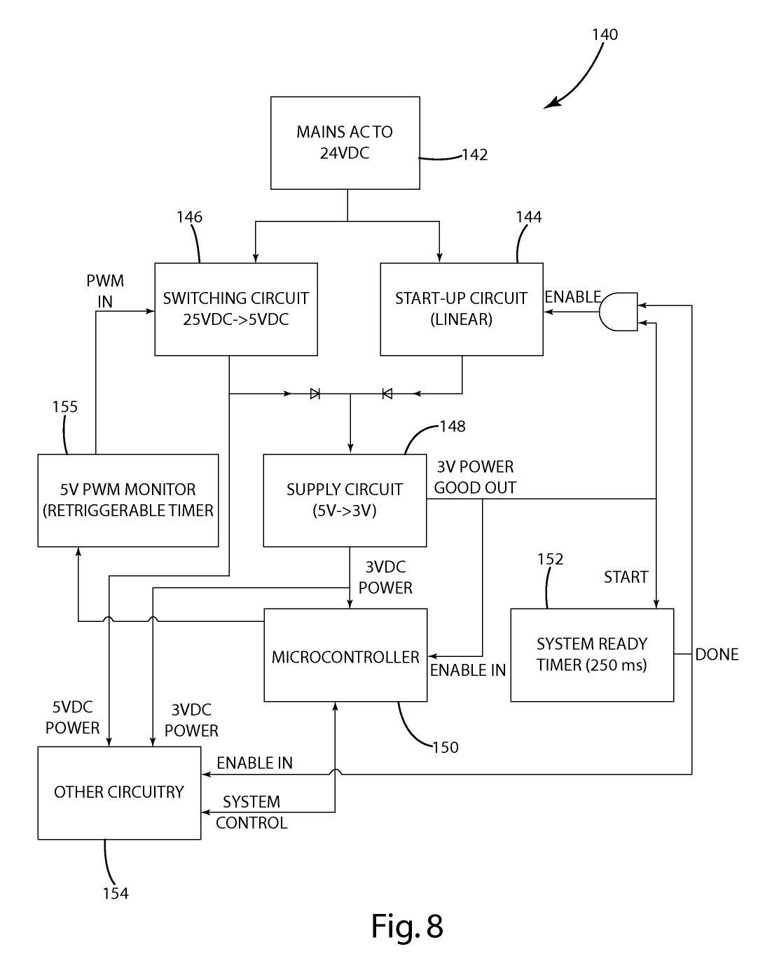

A sixth embodiment of the invention is shown in at FIGS. 8-10 and generally designated 140. In this embodiment, a power supply system 140 is configured to provide an operating voltage to a microcontroller 150 with minimal energy loss.

As shown in FIG. 8, the power supply system 140 includes a mains regulator 142, a trickle start-up circuit 144, a switching circuit 146, a microcontroller supply circuit 148, a system ready timer 152, and a microcontroller 150. The mains regulator 142 is adapted to convert a mains voltage into a regulated DC voltage for either of the switching circuit 146 or trickle start-up circuit 144. The switching circuit 146 and start-up circuit 144 are connected in parallel between the mains regulator 142 and the microcontroller supply circuit 148 for converting the regulated 24V DC source voltage into a 5V DC supply circuit input. The supply circuit 148 is adapted to convert the 5V DC supply circuit input into a supply circuit output to power the microcontroller 150. The supply circuit 148 includes a linear regulator adapted to covert a 5V DC input into 3V DC output. The supply circuit 148 is connected to the microcontroller 150 to provide 3V DC output to the microcontroller 150 and any additional circuits 154 as desired.

As further depicted in FIG. 8, the supply circuit 148 is adapted to transmit a signal to both the microcontroller 150 and the start-up circuit 144 indicating whether the output of the supply circuit 148 meets or exceeds a desired threshold voltage, for example 3V DC. The system ready timer 152 provides a delay, depicted as 250 milliseconds, during which time the microcontroller 150 resets and begins to transmit a switching signal across a voltage monitor 155 to the switching circuit 146 for generating the desired 5V DC input for the supply circuit 148. The system ready timer 152 is adapted to transmit a signal to the start-up circuit 144 to indicate the expiration of the 250 millisecond system ready timer delay. At the expiration of this delay, the start-up circuit 144 is disabled and the microcontroller 150 receives power through the switching circuit 146.

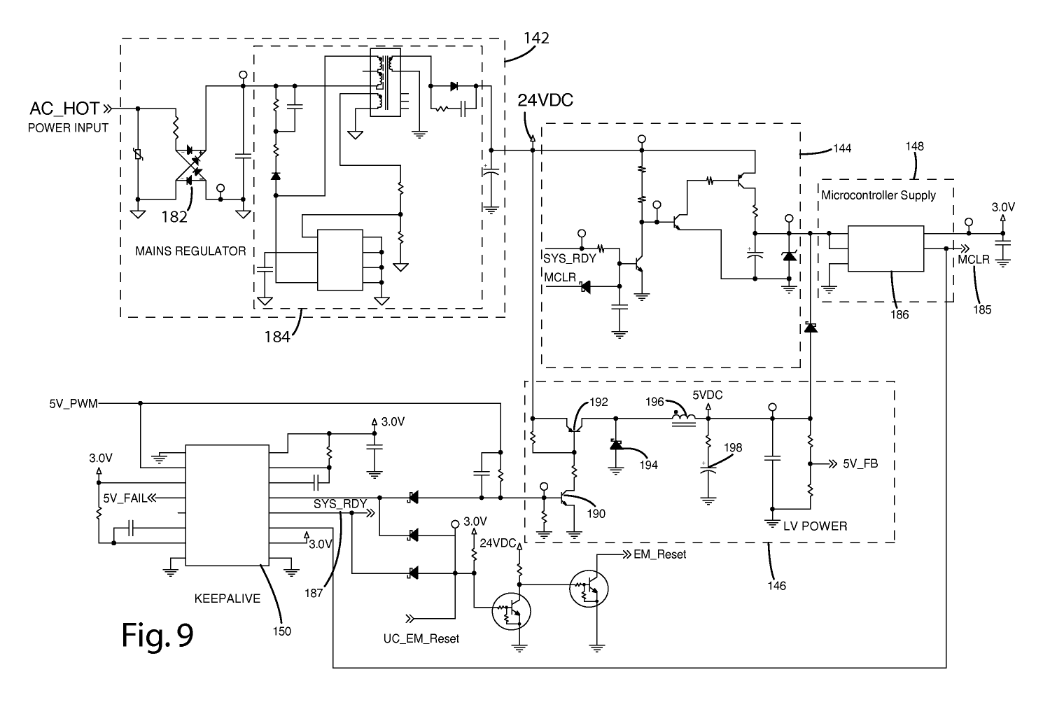

As further depicted in FIG. 9 with greater detail, the mains regulator 142 includes a bridge rectifier circuit 182 and a switching power supply 184, however any mains regulator for converting a mains voltage into a regulated DC voltage may also be utilized. The mains regulator 142 is connected to the trickle start-up circuit 144, which is connected in series between the mains regulator 142 and the supply circuit 148. The start-up circuit 148 includes a linear regulator 186 for converting the 24V DC source voltage into 5V DC start-up voltage, however any DC-to-DC converter may be used for converting the source voltage into a start-up voltage. The start-up circuit 144 is further connected to the MCLR output 185 of the supply circuit 148 and the SYS_RDY output 187 of the microcontroller 150. As explained in greater detail below, the start-up circuit 144 is disabled when two conditions are met: 1) the supply circuit 148 generates an supply voltage at threshold (indicating the start-up voltage or operating voltage is at least equal to a 5V DC reference voltage), and 2) a preset period of time elapses since detecting a supply voltage at threshold (depicted as 250 milliseconds). These two conditions are transmitted via the MCLR and SYS_RDY outputs 185, 187 respectively. Under a disabled condition, substantially no current flows through the start-up circuit 144 to the supply circuit 148. Under an enabled condition however, the start-up circuit 144 provides a regulated start-up voltage to the supply circuit 148, which then provides a supply voltage to the microcontroller 150.

As further shown in FIG. 9, the supply circuit 148 is connected in series between the start-up circuit 144 and the microcontroller 150 and includes a regulator 186, optionally a linear regulator, for converting the start-up or operating voltage into a supply voltage. The supply voltage is supplied to the microcontroller 150 to provide power for its basic operation, and for the operation of any number of associated circuits tied to the supply voltage. In addition to receiving a supply voltage from the supply circuit, the microcontroller 150 is adapted to receive a signal from the MCLR output 185 of the supply circuit 148 to indicate whether the supply voltage meets a threshold voltage. The microcontroller 150 is further adapted to reset if the MCLR output 185 is low, indicating the power supply system 140 is not generating the required operating voltage or start-up voltage. However, under a condition where the MCLR output 185 is high, the microcontroller 150 is adapted to begin transmitting or continue transmitting a switching signal to drive the switching circuit 146.

The switching circuit 146 is connected in series between the mains regulator 142 and supply circuit 148, and in parallel with the start-up circuit 144. The switching circuit 146 is adapted to convert the 24V DC source voltage into a 5V DC operating voltage in response to receiving the switching signal from the microcontroller 150. The switching circuit 146 includes a first transistor 190, a second transistor 192, a schottky diode 194, a filter inductor 196 and a filter capacitor 198. The first transistor 190 includes a base connected to the microcontroller 150, an emitter connected to ground, and a collector connected to the second transistor 192. The second transistor 192 includes an emitter connected to the 24V DC source voltage, and a collector connected to the filter inductor 196 and filter capacitor 198 for generating a 5V DC intermediate voltage. Under a condition where the MCLR output 185 is high, the microcontroller 150 creates a pulse width modulated or frequency modulated switching signal, which then cycles transistor 190 between the open and closed position. In response, switching circuit 146 produces a high frequency square wave having an average voltage approximately equal to the 24V DC source voltage multiplied by the duty cycle of the switching signal. The supply circuit 148 receives the output operating voltage, which is less than the 24V DC source voltage but the same polarity. The operating voltage is optionally measured by the microcomputer 150 for comparison against an internal reference voltage. Accordingly, the microcontroller and switching circuit 146 are adapted to provide a regulated 5V DC voltage to the supply circuit.

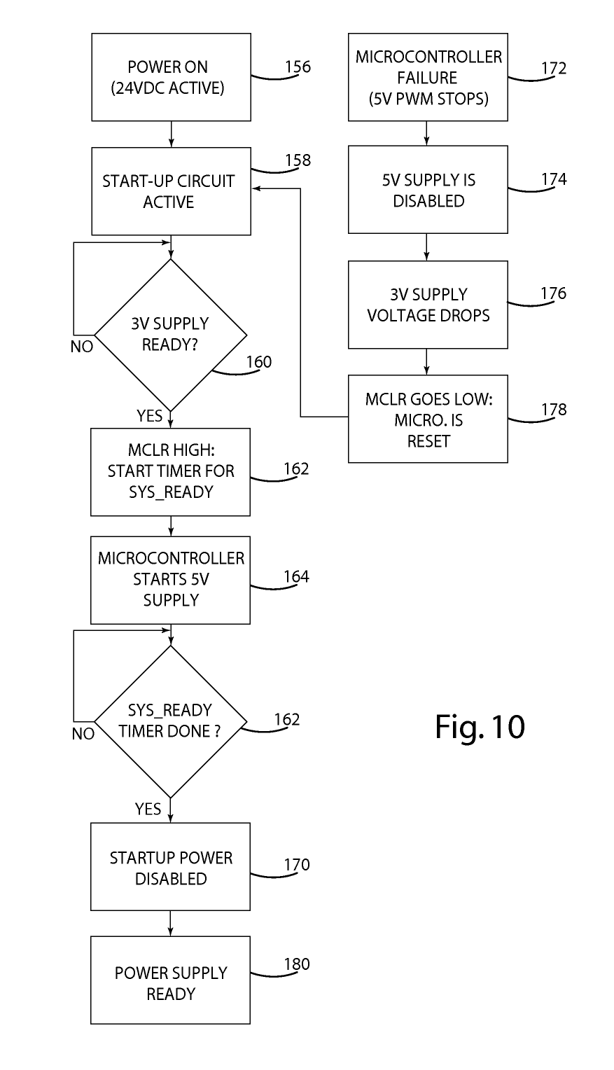

With reference to FIG. 10, a process for providing power to the microcontroller 150 in FIGS. 8-9 is disclosed. The process includes generating a source voltage at step 156, depicted as 24V DC. The source voltage is then applied across the start-up circuit 144 at step 158 for generating a regulated start-up voltage, for example 5V DC, which is then applied to the supply circuit 148 at step 160. When the supply circuit 148 provides a supply voltage meeting a pre-selected threshold voltage, for example 3V DC, the microcontroller 150 and start-up circuit 144 receive a signal indicating the same, illustrated at step 162. At step 162, the system ready timer 152 provides a delay, depicted as 250 milliseconds, during which time the microcontroller 150 transmits a switching signal to the switching circuit for generating the desired 5V DC operating voltage, depicted at step 164. At the expiration of the 250 millisecond delay in step 168, the start-up circuit 144 is disabled, depicted at step 170. If the microcontroller is operating correctly, the power supply system 140 provides a supply voltage to the microcontroller 150 through the switching circuit 146 as indicated in step 180. However, if for any reason the supply circuit 148 fails to generate an supply voltage at least equal to or greater than a threshold voltage, the switching circuit 146 will enter a disabled state at step 172, the microcontroller 150 will reset at step 178, and the start-up circuit 144 will begin converting the 24V DC source voltage into a 5V DC start-up voltage at step 158. After the expiration of the 250 milliseconds delay, the start-up circuit 144 is again disabled and the above sequence is allowed to repeat itself indefinitely until desired or steady state operation of the microcontroller 150 is achieved at step 180. Accordingly, the present embodiment provides a combined start-up and keep-alive sequence to provide a supply voltage to the microcontroller 150 through a microcontroller-controlled switching power supply 140.

The power supply system 140 of FIGS. 8-10 can be adapted for use in a lighting control assembly or any embedded device as desired. Additionally, the 24V DC source voltage can be uses to actuate one or more relays as described above. The power supply system can further include a protected input/output circuit for one or more occupancy sensors or a low voltage output for a dimmable ballast. The power supply system 140 is not limited to lighting applications, however, and can be used in any embedded device where it is desired to efficiently power a microcontroller.

### IV. MICROCONTROLLER-CONTROLLED POWER SUPPLY UTILIZING A RELAY COIL AS A FILTER INDUCTOR

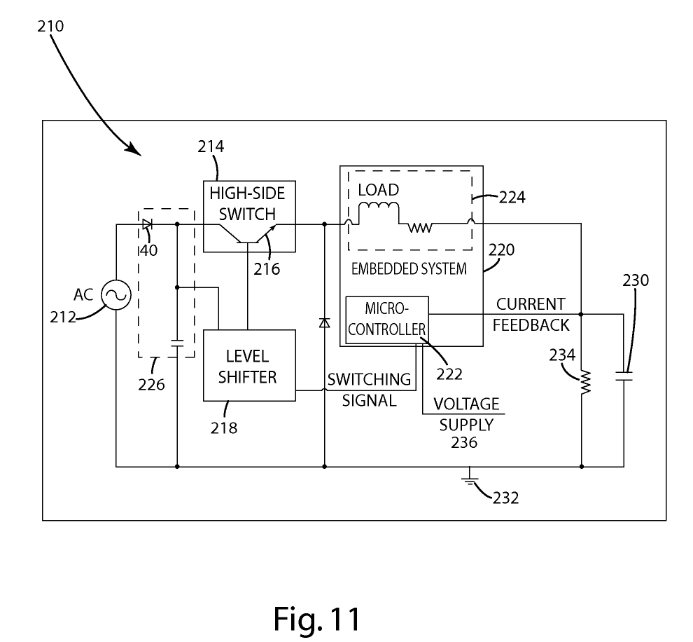

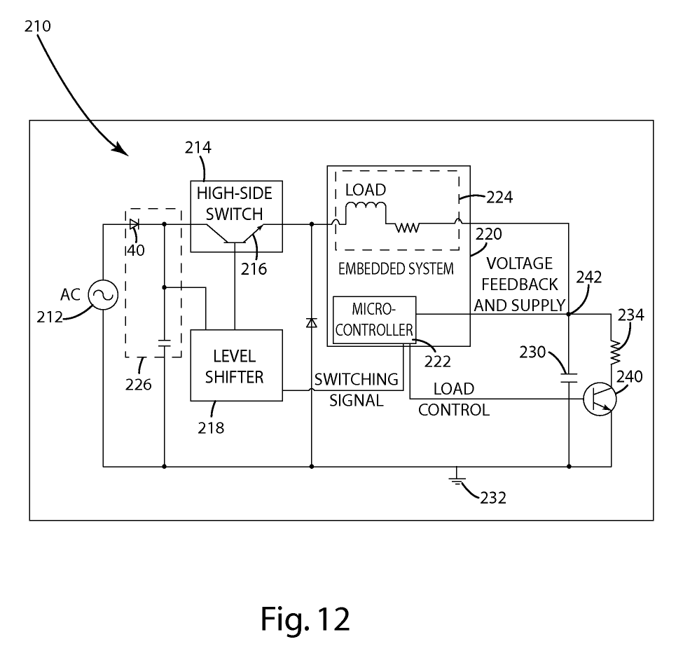

A seventh embodiment of the invention is shown in at FIGS. 11-12 and generally designated 210. In this embodiment, a power supply system 210 is configured to provide power across an inductive load used as part of a switching power supply.

As shown in FIG. 11, the power supply system 210 includes an alternating current power supply 212, a high side switch 214 including a switching transistor 216, a level shifter 218, an embedded system 220 including a microcontroller 222 and an inductive load 224, a capacitor 230, and a rectifier 226. The microcontroller 222 may be an application specific or embedded microcontroller 222 for the embedded device 220, optionally a wall timer, clock, battery charger, microwave, washing machine, or clothing dryer. The inductive load 224 includes an inductive element, for example a coil for a relay, an inductive ballast, or a motor. The inductive load 224 further includes an input and an output, the output being electrically connected to the microcontroller 222. The capacitor 230 is connected in series between the inductive load 224 and ground 232, and the inductive load 224 and capacitor 230 are adapted to smooth the voltage applied across the inductive load 224. The high side switch 214 transistor 216 is connected in series between the rectifier and the inductive load, wherein at least on of the collector element and emitter element is connected to the rectifier 226 and the remaining element is connected to the inductive load 224. The base of the transistor 216 is connected to the microcontroller 222 through the level shifter 218. In operation, the microcontroller transmits a switching signal to the switching transistor 216 within the high side switch 214 for generating an adjustable duty cycle voltage across the inductive load 224. The inductive load 224 and capacitor 230 smooth the applied voltage in the same manner an LC filter would in a conventional switching power supply. The average current through the inductive load 224 is optionally controlled by the microcontroller 222 by monitoring the voltage across resistor 234 and increasing or decreasing the duty cycle of the voltage applied across the inductive load 234.

The power supply system 210 of FIG. 11 illustrates a supply voltage 236 connected to the microcontroller 222, wherein the voltage supply 236 is providing power to the microcontroller 226 and does not otherwise interact with the power supply system 210. In another embodiment as shown in FIG. 12, the microcontroller 222 can receive a supply voltage from the output of the inductive load 224. As shown in FIG. 12, transistor 240 is connected in series between resistor 234 and ground 232, and the microcontroller 222 is connected to the base of transistor 240. When the transistor 240 is open, current through the inductive load 224 increases as a function of the resistor 234. When the transistor 240 is closed, current through the inductive load 224 decreases, however in both instances the power supply system 210 provides a nominal 3V DC supply voltage at node 242 for the microcontroller 222. Accordingly, the power supply system 210 of the current embodiment provides a constant DC supply voltage in conjunction with an inductive load 224 integral to the power supply 210, wherein the load inductance is used as the inductor in a microcontroller-controlled switching circuit.

In operation, an irregular voltage, optionally a pulsed DC waveform, is applied across the inductive load 224. The inductive load 224 and the capacitor 250 smooth the voltage applied across the inductive load 224. The microcontroller 222 measures the voltage at node 242, which is at least proportional to, if not equal to, the voltage applied across the inductive load 224. The microcontroller 222 then compares a property of the output voltage, for example its average voltage over time, with a property of a reference voltage. The microcontroller 222 then modulates the irregular voltage applied across the inductive load 224 to achieve a desired supply voltage for either of the load 224 in FIG. 11 or the microcontroller in FIG. 12. As noted above, the step of modulating the irregular voltage includes providing a switching signal from the microcontroller 222 to the switching transistor 216. Optionally, the switching signal is at least one of a pulse width modulated switching signal and frequency modulated switching signal.

### V. CONCLUSION

The above descriptions are those of current embodiments of the invention. Various alterations and changes can be made without departing from the spirit and broader aspects of the invention as defined in the appended claims, which are to be interpreted in accordance with the principles of patent law including the doctrine of equivalents. Any reference to a claim element in the singular, for example, using the articles “a,” “an,” “the,” or “said,” is not to be construed as limiting the element to the singular.

1. A power supply system comprising:
a relay adapted to provide a source voltage when the relay is in a first state;
a switching circuit electrically connected to the relay;
an embedded controller electrically connected to the switching circuit, the controller adapted to transmit a switching signal to the switching circuit for generating an adjustable duty cycle pulsed voltage to provide power to the controller and to actuate the relay; and
a zero crossing circuit electrically connected between the source voltage and the controller, the zero crossing circuit adapted to detect zero crossover in the source voltage and transmit a zero crossing signal to the controller, wherein the controller is adapted to transmit the switching signal in advance of a subsequent zero crossover to place the relay in the first state substantially at the subsequent zero crossover of the source voltage.

2. The power supply system of claim 1, wherein the relay includes a relay coil and at least two switch contacts, the at least two switch contacts adapted to provide a conducting path for the source voltage when the relay is in the first state.

3. The power supply system of claim 2, wherein the switching signal induces a start up voltage across the relay coil followed by a holding voltage across the relay coil, wherein the start up voltage is greater than the time average of the holding voltage.

4. The power supply system of claim 3 further comprising a voltage feedback circuit connected in series between the relay and the controller, the controller adapted to provide at least one of a pulse width modulated switching signal and frequency modulated switching signal to the switching circuit for inducing a holding voltage across the relay coil proportional to the duty cycle of the switching signal.

5. The power supply system of claim 4, wherein the switching circuit includes a transistor, the transistor including at least one of an emitter and collector electrically connected to the relay coil, the transistor including a base electrically connected to the controller.

6. The power supply system of claim 2 further including a rectifying circuit connected to the relay coil to rectify the source voltage.

7. The power supply of claim 2, wherein the relay coil is adapted to smooth the voltage applied across the relay coil.

8. The power supply of claim 1, wherein the embedded controller is an embedded microcontroller within an embedded device.

9. The power supply of claim 8, wherein the embedded device is a wall timer.

10. A method of actuating a relay in an embedded device, comprising;
sensing a zero crossover in a source voltage to be provided to a relay;
providing a zero crossover signal to an embedded controller in response to the sensing step; and
applying a voltage across the relay in advance of a subsequent zero crossover to close the relay substantially at the subsequent zero crossover of the source voltage.

11. The method of claim 10 wherein the applying step further applying a start up voltage across a relay coil followed by a holding voltage across the relay coil, wherein the start up voltage is greater than the time average of the holding voltage.

12. The method of claim 11 further comprising the steps of:
providing a switching circuit in series between the controller and the relay coil;
measuring a voltage across the relay coil;
comparing the voltage across the relay coil with a reference voltage;
providing at least one of a pulse width modulated switching signal and frequency modulated switching signal to the switching circuit, wherein the holding voltage across the relay coil is proportional to the duty cycle of the switching signal.

13. The method of claim 12, wherein the switching circuit includes a transistor having at least one of an emitter and collector electrically connected to the relay coil and having a base electrically connected to the controller.

14. A power supply control system comprising:
a controller adapted to receive a start-up voltage during controller start-up and an operating voltage during controller steady state operation;
a start-up circuit electrically connected to the controller and adapted to provide the start-up voltage to the controller during controller start-up until a criteria is met;
a switching circuit electrically connected to the controller and adapted to provide the operating voltage to the controller, the controller being adapted to transmit a switching signal to the switching circuit to provide the operating voltage during steady state operation of the controller.

15. The power supply control system of claim 14, wherein the criteria includes a start-up voltage greater than a predetermined threshold voltage for a predetermined period of time.

16. The power supply control system of claim 14 further comprising a supply circuit coupled to the start-up circuit and the switching circuit, the supply circuit adapted to convert an input voltage into a supply voltage for the controller, the input voltage including at least one of the start-up voltage and operating voltage.

17. The power supply control system of claim 16, wherein the supply circuit is adapted to transmit a signal to at least one of the controller and the start-up circuit indicating the supply voltage is less than a reference voltage, the controller being further adapted to reset in response to the signal.

18. The power supply control system of claim 14, wherein the switching signal includes a pulsed waveform switching signal.

19. The power supply control system of claim 14 further comprising a mains regulator electrically connected to the start-up circuit and the switching circuit for providing power across at least one of the start-up circuit and the switching circuit.

20. The power supply control system of claim 14, wherein the controller is an embedded microcontroller.

21. A method of providing power to a controller, comprising;
generating a start-up voltage across a first voltage source;
providing the start-up voltage to the controller;
disabling the first voltage source when the controller receives an input voltage greater than a predetermined threshold voltage for a predetermined period of time;
transmitting a switching signal to the switching circuit to provide an operating voltage; and
providing the operating voltage to the controller during steady state operation of the controller in response to the transmitting step.

22. The method of providing power to a controller according to claim 21, the method further comprising the steps of:
converting at least one of the start-up voltage and operating voltage into a supply voltage across a linear regulator; and
providing the supply voltage to the controller.

23. The method of providing power to a controller according to claim 22, wherein the switching signal is a pulsed waveform.

24. The method of providing power to a controller according to claim 23, the method further comprising the step of resetting the controller in response to a signal indicating the supply voltage is less than the threshold voltage.

25. The method of providing power to a controller according to claim 24, wherein the start-up voltage is substantially equal to the operating voltage.

26. The method of providing power to a controller according to claim 25, wherein the first voltage source is at least one of a linear power supply and switching power supply.

27 The method of providing power to a controller according to claim 26, wherein the controller is an embedded microcontroller.

28. A power supply system comprising:
a controller;
an inductive load having an output electrically connected to the controller;
a capacitor connected to the inductive load, the inductive load and the capacitor adapted to smooth an input voltage across the inductive load; and
a first transistor including a collector element, an emitter element and a base element, at least one of the collector element and emitter element electrically connected to the input of the inductive load, the base element electrically connected to the controller, wherein the controller is adapted to transmit a switching signal to the first transistor for generating an adjustable duty cycle pulsed voltage to provide power to the controller across the inductive load.

29. The power supply system of claim 28 further comprising a rectifying circuit connected to the first transistor for rectifying an alternating current power supply.

30. The power supply system of claim 28 further comprising a second transistor including a base element electrically connected to the controller, a resistor connected in series between the output of the inductive load and at least one of an emitter and collector of the second transistor.

31. The power supply system of claim 28, wherein the inductive load includes a relay coil.

32. A method of regulating a power supply, comprising:
applying an irregular voltage across an inductive load to create an output voltage;
smoothing the output voltage using at least the inductive load;
measuring a property of the output voltage;
comparing the property of the output voltage with a reference property using a controller;
modulating the irregular voltage applied across the inductive load using the controller in response to the comparing step.

33. The method of regulating a power supply according to claim 32, wherein the irregular voltage is a pulsed DC waveform.

34. The method of regulating a power supply according to claim 33, wherein the property of the output voltage is a time average voltage of the output voltage.

35. The method of regulating a power supply according to claim 34 further including the step of providing the output voltage to the controller to power the controller.

36. The method of regulating a power supply according to claim 34, wherein the smoothing step includes a capacitor electrically connected to the inductive load.

37. The method of regulating a power supply according to claim 35, wherein the modulating step includes providing a switching signal from the controller to a transistor connected in series between a voltage source and the inductive load.

38. The method of regulating a power supply according to claim 36, wherein the switching signal is at least one of a pulse width modulated switching signal and frequency modulated switching signal.
